(19) United States
(12) Patent Application Publication
(10) Pub. No.: US 2013/0268231 A1
(43) Pub. Date: Oct. 10, 2013

(54) SENSOR SYSTEM AND SENSOR MODULE IDENTIFICATION METHOD

(71) Applicant: SEIKO EPSON CORPORATION, Tokyo (JP)

(72) Inventor: Masatoshi SATO, Hashima (JP)

(73) Assignee: Seiko Epson Corporation, Tokyo (JP)

(21) Appl. No.: 13/855,983

(22) Filed: Apr. 3, 2013

(30) Foreign Application Priority Data
Apr. 6, 2012 (JP) 2012-087126

(51) Int. Cl. G08C 19/00; G01P 3/00; G01P 15/00

(52) U.S. Cl. CPC G08C 19/00; G01P 15/00; G01P 3/00
USPC 702/141; 702/189; 702/145

(57) ABSTRACT

A sensor system includes: plural sensor modules, each having a unique ID; a connecting unit which has plural ports, each having the sensor module connected thereto and having a unique address allocated thereto; a voltage generating unit which generates a different voltage for each of the addresses and supplies the voltage to each of the plural sensor modules; and a control unit which communicates with the sensor modules via the connecting unit. The sensor module determines the address of the port based on the voltage from the voltage generating unit, and transmits a predetermined physical quantity that is detected and the unique ID to the control unit.

### BACKGROUND

1. Technical Field

The present invention relates to a sensor system and a sensor module identification method and the like.

2. Related Art

In a system in which plural devices, for example, sensor modules, are connected to use the system, each device may need to be connected at a specific position. In this case, a connection error due to a human error may occur. When a connection error is made, there is a problem, for example, that detected data is inaccurate.

To prevent connection errors, wireless connection may be carried out in such a system. However, the cost of the system increases and power consumption increases as well.

Thus, a system in which connection errors can be prevented by providing a function to identify the connection state while carrying out wired connection is proposed. For example, according to the technique disclosed in JP-A-2001-95748, all the devices have a connection identification terminal, enabling the connection state to be displayed.

In such a system, plural devices of the same type may be connected to use the system. In the technique of JP-A-2001-95748, when IDs indicating the device type have the same fixed part, an individual number is allocated to a variable part of the IDs, so that competition among the devices can be avoided and the devices of the same type can be used.

However, in this method, every time the devices are reconnected, the individual number (variable part of the ID) changes and it is difficult to specify which device is connected at which position. For example, it is assumed that the devices are sensor modules with individual differences and need to be corrected individually. In this case, if sensor modules of the same type exist in the system, the sensor modules cannot be corrected accurately.

### SUMMARY

According to some aspects of the invention, a sensor system in which wire-connected sensor modules can be identified individually without fixing the connecting positions of the sensor modules can be provided.

(1) An aspect of the invention is directed to a sensor system including: plural sensor modules, each having a unique ID; a connecting unit which has plural ports, each having a unique address allocated thereto, and which connects the sensor modules to each of the ports; a voltage generating unit which generates a different voltage for each of the addresses and supplies the voltage to each of the plural sensor modules; and a control unit which communicates with the sensor modules via the connecting unit. The sensor module determines the address of the port based on the voltage from the voltage generating unit, and transmits a physical quantity that is detected and the unique ID to the control unit.

In the sensor system according to this aspect, the sensor modules are connected to the ports of the connecting unit to use the system. At this point, the connection between the sensor modules and the ports is not fixed, and each sensor module is connectable to any of the plural ports. Here, a sensor module connected to a port receives the voltage corresponding to the address of that port from the voltage generating unit and thus can determine the port with which address the sensor module is connected. Then, for example, when a transmission instruction designating the address of that port is given by the control unit, the sensor module transmits the data of the detected physical quantity and the sensor module's own ID. Therefore, the control unit can grasp which sensor module is connected to which port.

Here, the ports included in the connecting unit are wired communication ports. Therefore, there are no problems such as increase in cost and power consumption as in the case of wireless communication. Wired communication can use methods such as UART or I²C but is not limited to specific method.

When the sensor module is connected to the port, the sensor module receives the voltage corresponding to the address of that port from the voltage generating unit. The sensor module has only one additional input terminal for receiving the voltage and does not need a connection identification terminal or a dedicated cable for bidirectional communication as in the technique of JP-A-2001-95748. The voltage generating unit may be included in the connecting unit or may be provided separately from the connecting unit.

Also, since the connecting positions of the sensor modules are not fixed, when one sensor module fails, this sensor module can be replaced immediately with a sensor module of the same type. That is, stable operation as the system can be realized.

The control unit grasps which sensor module is connected to which port and therefore can execute, for example, proper correction corresponding to individual sensor modules.

(2) In this sensor system, the control unit may include a reference voltage generating unit which supplies a reference voltage to the voltage generating unit. The voltage generating unit may perform resistive division of the reference voltage and thus may generate different voltages from each other corresponding to the address.

(3) In this sensor system, the voltage generating unit may include plural resistor ladder circuits in which resistance elements are connected in series, and a resistance value of the resistor elements may be decided in such a way that all the voltages obtained by resistive division of the reference voltage differ from each other.

(4) In this sensor system, the sensor module may receive information of the reference voltage and the number of the ports from the control unit via the connecting unit before detecting the physical quantity.

According to the aspects of the invention described above, the voltage generating unit performs resistive division of the reference voltage and thus generates different voltages from each other corresponding to the address of the port. In this case, since different voltages from each other can be generated by the resistor ladder circuit in which the resistance elements are connected in series, increase in circuit scale can be restrained.

Here, the voltage generating unit may include plural resistor ladder circuits. In this case, the sensor system can be constructed without laying wires around even when the ports are physical apart.

Also, when the resistor ladder circuit is made up only of a basic resistance element and a resistance element having an integral multiple of the resistance value of the basic resistance element, the sensor module can obtain information of the reference voltage and the number of the ports included in the connecting unit and thus can grasp the relation between the address of the port and the voltage by simple calculation. Therefore, a flexible sensor system that can cope with changes in the reference voltage and increase or decrease in the number of ports can be constructed.

(5) In this sensor system, the sensor module may include at least one of an acceleration sensor and an angular velocity sensor.

According to this aspect of the invention, the sensor modules may include at least one of an acceleration sensor and an angular velocity sensor. In this case, in the sensor system, since the connected sensor modules are individually recognized, proper correction can be made to the individual sensor modules. Therefore, accurate acceleration and angular velocity can be detected.

(6) Another aspect of the invention is directed to a sensor module identification method including: causing a sensor module connected to a port and having a unique ID, to determine an address of the port; and causing the sensor module to transmit a physical quantity that is detected and the unique ID to a control unit.

In the sensor module identification method according to this aspect, the sensor module connected to one of the ports receives a voltage corresponding to the address of that port, for example, from a voltage generating unit, and determines the address of the port.

For example, when a transmission instruction designating the address of that port is given by the control unit, the sensor module transmits the data of the detected physical quantity and the sensor module's own ID. In this case, the control unit can determine which sensor module is connected corresponding to the address of the port.

In the above sensor module identification method, the wire-connected sensor modules can be identified individually without fixing the connecting positions of the sensor modules.

### BRIEF DESCRIPTION OF THE DRAWINGS

The invention will be described with reference to the accompanying drawings, wherein like numbers reference like elements.

FIG. 1 is a block diagram of a sensor system according to an embodiment.

FIG. 2 is a block diagram of a sensor module according to an embodiment.

FIGS. 3A and 3B illustrate a connection state and a command according to a related-art example.

FIGS. 4A and 4B illustrate a connection state and a command according to an embodiment.

FIG. 5 illustrates an example of configuration of a voltage generating unit according to an embodiment.

FIG. 6 illustrates a garment provided with a sensor system.

FIG. 7 illustrates another example of configuration of a voltage generating unit.

FIG. 8 is a flowchart showing control of a sensor module according to an embodiment.

### DESCRIPTION OF EXEMPLARY EMBODIMENTS

Hereinafter, preferred embodiments of the invention will be described in detail with reference to the drawings. The embodiments described below are not to unduly limit the contents of the invention described in the appended claims. Not all the configurations described below are essential components of the invention.

### 1. Configuration of Sensor System

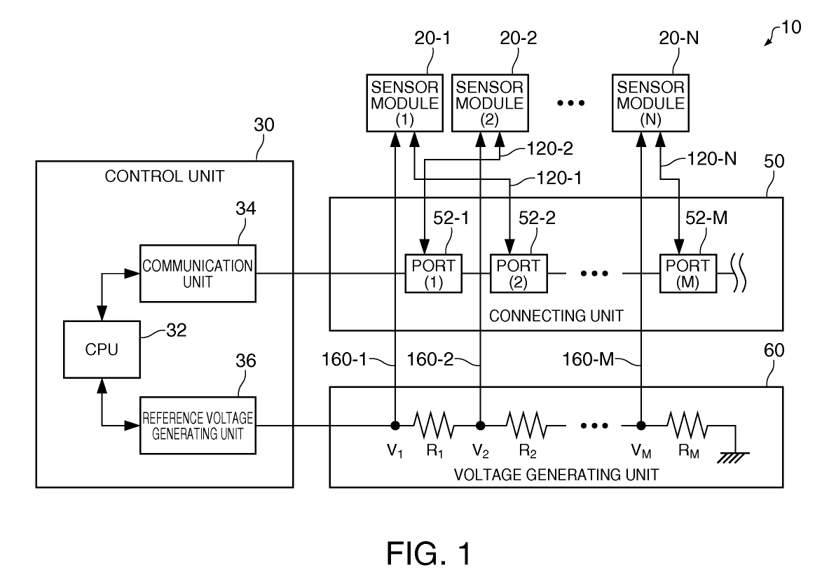

FIG. 1 is a block diagram of a sensor system 10 according to a preferred embodiment. As shown in FIG. 1, the sensor system 10 of this embodiment includes N sensor modules 20-1 to 20-N, a control unit 30, a connecting unit 50, and a voltage generating unit 60.

The control unit 30 includes a CPU 32, a communication unit 34, and a reference voltage generating unit 36. The connecting unit 50 includes ports 52-1 to 52-M to connect up to M sensor modules of the sensor modules 20-1 to 20-N. M, N, and J, later described, are natural numbers and hold the relation of J≦M≦N in the following description unless otherwise stated.

In FIG. 1, the numbers in brackets attached to the sensor modules 20-1 to 20-N are IDs that are unique to the respective sensor modules. The numbers in brackets attached to the ports 52-1 to 52-M are unique addresses allocated to the respective ports. These IDs and addresses need not be such consecutive numbers and may be inconsecutive numbers, letters or combinations thereof unless these numbers or letters overlap each other. For example, as unique IDs of the sensor modules 20-1 to 20-N, the manufacture's serial numbers or the like of the respective sensor modules 20-1 to 20-N may be used.

All or some of the N sensor modules 20-1 to 20-N are sensor modules of the same type. In this embodiment, all the sensor modules are of the same type and the configuration thereof will be described later.

The connection between the ports 52-1 to 52-M and the sensor modules 20-1 to 20-N is not fixed. For example, in FIG. 1, the sensor module 20-1 with an ID of 1 is connected to the port 52-2 with an address of 2. This sensor module 20-1 may be connected to the port 52-1 or may be connected to the port 52-M.

The control unit 30 includes the communication unit controlled by the CPU 32 of the control unit 30 and communicates with the sensor modules 20-1 to 20-N connected via the ports 52-1 to 52-M. The communication in this case is wired communication using a method such as UART or I²C.

Signals 120-1 to 120-N inputted to or outputted from the sensor modules 20-1 to 20-N are inputted to and outputted from the communication unit 34 via the ports 52-1 to 52-M. Here, only the sensor modules connected to the ports 52-1 to 52-M, of the N sensor modules 20-1 to 20-N, communicate with the communication unit 34.

As will be described in detail later, the control unit 30 sends a transmission instruction designating the address of a port to the sensor modules 20-1 to 20-N and can specify the connected sensor module based on the ID included in the response from the sensor module. Therefore, though the connection between the ports 52-1 to 52-M and the sensor modules 20-1 to 20-N is not fixed, the control unit 30 can grasp which sensor module is connected.

The control unit 30 receives, for example, a predetermined physical quantity detected by the connected sensor module. At this time, since the control unit 30 has a grasp of the sensor module's ID, the control unit 30 can properly correct, for example, variance or the like due to the individual difference of the sensor module. The control unit 30 may transmit the resulting corrected data to a device outside the sensor system 10 via the communication unit 34 or another communication measure (not shown).

Here, the sensor modules connected to the ports 52-1 to 52-M cannot respond to the transmission instruction designating the address of the port from the control unit 30, unless the sensor modules had a grasp of the address of the port.

In this embodiment, the voltage generating unit 60 generates voltages V₁, V₂, . . . V_{M} that are different from each other, corresponding to the addresses 1, 2, . . . M of the ports. The voltage generating unit 60 of this embodiment generates these voltages by performing resistive division, as shown in FIG. 1, of a reference voltage generated by the reference voltage generating unit 36 controlled by the CPU 32. Therefore, the voltage generation can be realized with a simple circuit and there is no increase in circuit scale.

These voltages V₁, V₂, . . . , V_{M} are supplied to the sensor modules connected to the ports of the corresponding addresses, as signals 160-1 to 160-M of FIG. 1. For example, the ports 52-1 to 52-M may have a structure provided with plural pins for electrical connection, and a voltage corresponding to the address of the port may be allocated to one of these pins. The voltage generating unit 60 may be included in the connecting unit 50.

In this embodiment, the CPU 32 uses the communication unit 34 to transmit the reference voltage from the reference voltage generating unit 36 and the number of the ports 52-1 to 52-M (in FIG. 1, M) to the connected sensor modules. As will be described in detail later, the sensor modules can determine the address of the port by simple calculation.

### 2. Configuration of Sensor Module

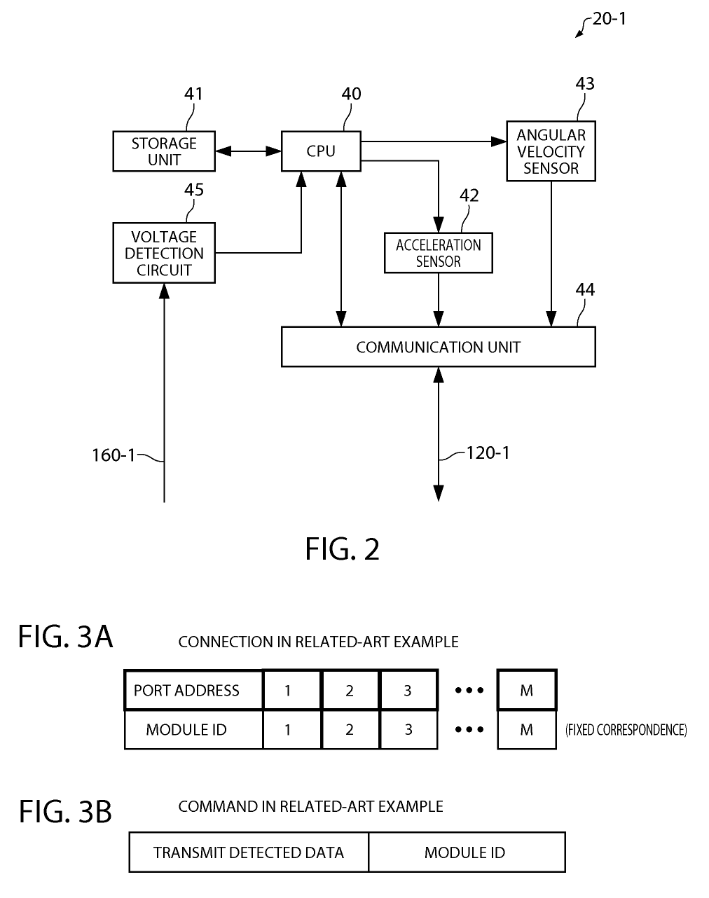

FIG. 2 is a block diagram of the sensor module 20-1 of this embodiment. Here, the sensor module 20-1 is taken as an example, but in this embodiment, the sensor modules 20-2 to 20-N have the same configuration, too. The same elements as in FIG. 1 are denoted by the same reference numerals and will not be described further in detail.

The sensor module 20-1 includes a CPU 40, a storage unit 41, an acceleration sensor 42, an angular velocity sensor 43, a communication unit 44, and a voltage detection circuit 45. First, the case where the sensor module 20-1 is connected to one of the ports will be described.

The signal 160-1, which is an analog voltage corresponding to the address of the port, is inputted to the voltage detection circuit 45. In this case, the voltage detection circuit 45 may include, for example, an AD converter and may convert the analog signal to a digital signal and output the digital signal so that the CPU 40 can execute a voltage determination process, described later. The voltage determination process is a process in which the address of the connected port is determined based on the received voltage. Alternatively, the voltage detection circuit 45 may receive necessary data (not shown) from the CPU 40, execute the voltage determination process within the voltage detection circuit 45, and output only the address of the connected port to the CPU 40. In this case, the processing load on the CPU 40 is reduced.

The CPU 40 stores the address, obtained as a result of the voltage determination process or received from the voltage detection circuit 45, into the storage unit 41. The storage unit 41 includes at least a RAM to store the address. The storage unit 41 may also include a ROM, flash memory or the like as well as the RAM. In these non-volatile memories, for example, programs of the CPU and the unique ID of the sensor module 20-1 are stored.

Next, the case where the CPU 40 receives a command (instruction) from the control unit (see FIG. 1) as the signal 120-1 will be described. In this case, the CPU 40 compares the address included in the signal 120-1 with the address stored in the storage unit 41. If the addresses match, the CPU 40 carries out an operation corresponding to the command. For example, if the command is an instruction to start measuring acceleration or angular velocity, the CPU 40 causes the acceleration sensor 42 or the angular velocity sensor 43 to do the measuring. If the command is a transmission instruction, the CPU 40 causes the communication unit 44 to transmit the measuring result from the acceleration sensor 42 or the angular velocity sensor 43 and the unique ID of the sensor module 20-1.

In this case, the sensor module 20-1 need not know which other sensor module is connected at which position. For example, there is a technique (hereinafter referred to as a related-art example) of fixed connection in which a specific sensor module is connected to a specific port. Compared with this related-art example, the sensor module simply has one input terminal to receive the voltage corresponding to the address of the port and the addition of the voltage detection circuit 45. However, the connection no longer needs to be fixed and the problem of a connection error due to a human error can be solved.

The sensor module 20-1 of this embodiment may be an IMU (Inertial Measurement Unit) including three acceleration sensors 42 and three angular velocity sensors 43 provided respectively on three axes that are orthogonal to each other. The number and type of sensors included are not limited to this example. For example, the sensor module may further include a magnetic sensor, temperature sensor, atmospheric pressure sensor or the like.

### 3. Connection of Sensor Module

Here, while the connection between the sensor modules and the ports is described as not fixed in this embodiment, several examples of connection will be compared with the related-art example.

The above related-art example can be taken as a related-art technique for a system in which sensor modules connected to ports can be specified individually. That is, the relate-art example is a technique of fixed connection which prescribes that a specific sensor module is connected to a specific port. In the related-art example, ports addresses and sensor module IDs have one-to-one correspondence, as shown in FIG. 3A. By such fixed connection, the control unit (see FIG. 1) can grasp which sensor module is connected to which port.

In this case, the control unit uses a command as shown in FIG. 3B to request transmission of data detected by the sensor module. This command includes a code to order transmission of the detected data and an ID which designates a sensor module. Since the connection is fixed, a port address may be used instead of the ID which designates a sensor module.

However, in the related-art example, when there is a connection error due to a human error, the control unit continues processing without noticing the error. The connection error may be, for example, in the example of FIG. 3A, the connection of the sensor module with the ID of 3 to the port with the address 1. Therefore, there is a problem, for example, that correction is not properly made and therefore correct data cannot be obtained.

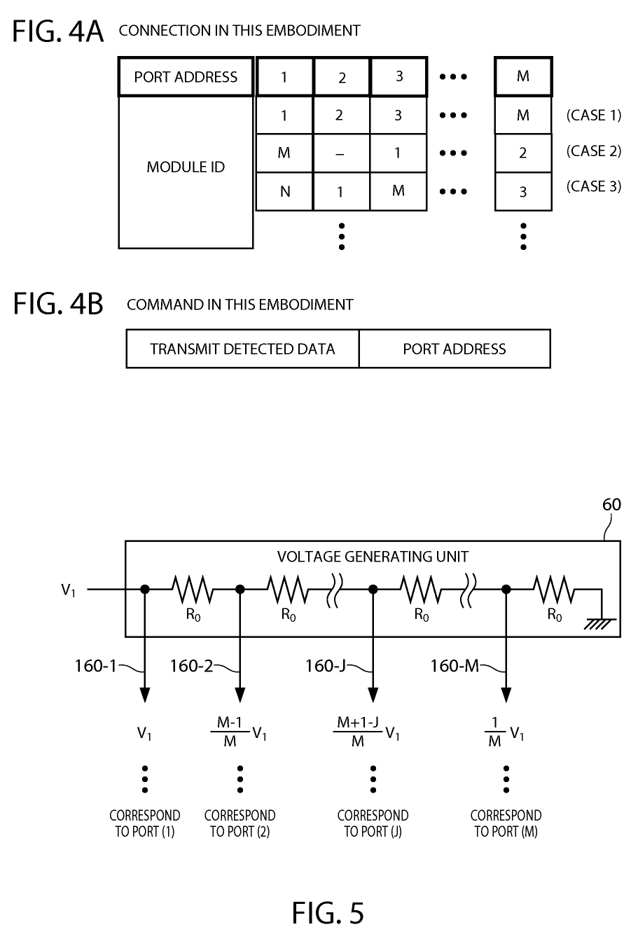

On the other hand, FIG. 4A is an example of sensor module connection in the sensor system of this embodiment. While the sensor modules can be connected similarly to the related-art example (case 1), the port addresses and sensor module IDs can be connected randomly as in case 2. For example, the sensor module with the ID of M determines the corresponding port address (1), based on the voltage received when the sensor module is connected to the port.

The control unit (see FIG. 1) uses a command as shown in FIG. 4B to request transmission of data detected by the sensor module. This command uses the port address, unlike the related-art example (FIG. 3B). When the address designated by the command is 1, the sensor module with the ID of M transmits the detected data and the ID of M. Based on this response, the control unit grasps that the sensor module with the ID of M is connected to the port with the address 1, and executes, for example, suitable correction for this sensor module.

In case 2 of FIG. 4A, no sensor module is connected to the port with the address of 2. In this case, the control unit can easily confirm the unconnected state, for example, by executing the command of FIG. 4B while changing the port address in order. That is, the port can be determined as unconnected when there is no response from any sensor module. In this case, if there is a response to the subsequent addresses (in the example of FIG. 4A, the address 3 and after), it may be determined that there is a connection error. If there is no response to all the subsequent addresses, it may be determined that the user is carrying out partial connection on purpose.

Case 3 is an example of connection where M<N holds. For example, this applies to the case where, though the sensor module with the ID of 2 is first connected to the port with the address of 1, there is a failure and therefore the sensor module of the same type with the ID of N is connected instead. In this case, too, the sensor system of this embodiment operates without any problem. Also, the control unit can grasp which sensor module is connected to which port.

The sensor module ID can be transmitted without accompanying the detected data. For example, the command of FIG. 4B may be a command having a code to transmit the ID only (hereinafter referred to as an ID transmission command) instead of the code to order transmission of the detected data. Thus, the sensor module may transmit the ID only, in response to the ID transmission command.

### 4. Configuration of Voltage Generating Unit

FIG. 5 illustrates an example of configuration of the voltage generating unit 60 of this embodiment. The same elements as in FIG. 1 are denoted by the same reference numerals and will not be described further in detail. FIG. 5 shows the case where all of R₁, R₂, . . . R_{M} in the voltage generating unit 60 in FIG. 1 are the same resistance value R₀. In this case, the different voltages from each other corresponding to the port addresses, generated through the resistive division by the voltage generating unit 60, can be found by simple calculation.

As shown in FIG. 5, the reference voltage V₁ generated by the reference voltage generating unit 36 (see FIG. 1) is divided by M resistance elements with the resistance value R₀. Thus, as J≦M holds, the voltage corresponding to the port address J is expressed by (M+1−J)×V₁/M. Hereinafter, this formula is called a voltage calculation formula.

Therefore, if the reference voltage V₁ and the number of ports M are provided as prior information from the control unit, the sensor module can find the address J, using the voltage calculation formula and based on the voltage received from the voltage generating unit 60.

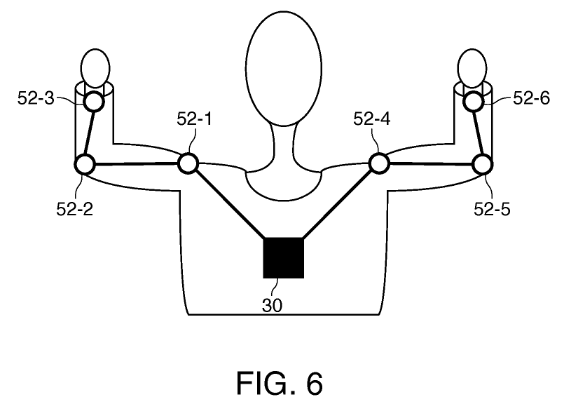

Here, the voltage generating unit 60 of FIG. 5 is made up of one resistor ladder circuit. However, when the ports are physically apart to the left and right, as shown in FIG. 6, it may be preferable that the voltage generating unit includes plural (in this case, two) resistor ladder circuits according to the ports. Hereinafter, an example in which the above voltage calculation formula can also be used in the voltage generating unit 60 including plural resistor ladder circuits using a resistance that is an integral multiple of the unit resistance value R₀ will be described.

FIG. 6 shows a sensor system in which ports 52-1 to 52-6 are provided corresponding to left and right shoulders, elbows and wrists in order to detect movements of human arms, and sensor modules are connected to the respective ports to use the sensor system. This sensor system is incorporated in a garment. In this case, it is preferable that the control unit 30 is arranged at a central part and two physically separate communication systems are provided, that is, a communication system including the ports 52-1 to 52-3 for the right arm and a communication system including the ports 52-4 to 52-6 for the left arm.

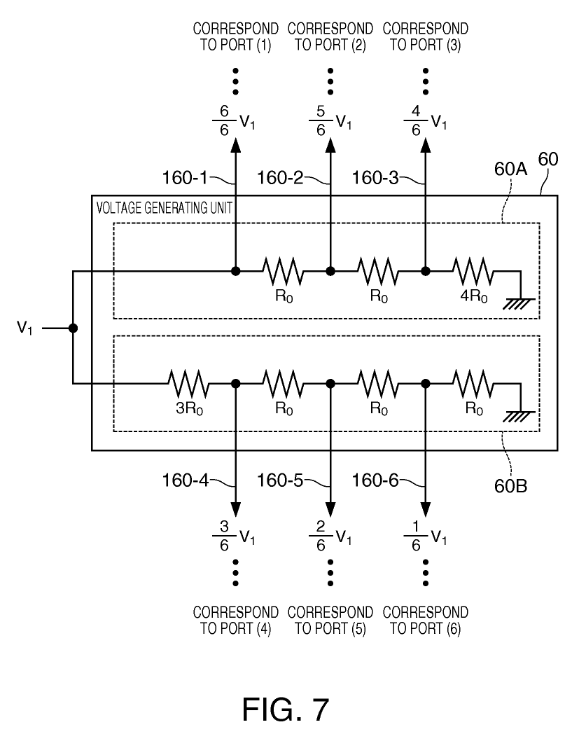

Here, when the voltage generating unit 60 having the configuration of FIG. 5 is used, wires are extended to the right wrist, then folded back to the center and extended to the left wrist. That is, the wires are laid around extended areas and there is a possibility that movements of the arms cannot be detected properly. In such case, the voltage generating unit 60 having the configuration of FIG. 7 may be used.

The voltage generating unit 60 of FIG. 7 includes two resistor ladder circuits 60A, 60B. These resistor ladder circuits can correspond respectively to the communication system including the right arm ports (addresses 1 to 3) and the communication system including the left arm ports (addresses 4 to 6).

In this case, resistance elements having a resistance value that is an integral multiple of the unit resistance value R₀ are arranged as shown in FIG. 7 so that nodes to output a voltage (nodes to draw out signals 160-1 to 160-6) in the two resistor ladder circuits differ from each other.

For example, the sensor module connected to the port with the address 2 allocated thereto receives a voltage of (⅚)V₁. This coincides with the result of M=6, J=2 obtained from the voltage calculation formula. Also, for example, the sensor module connected to the port with the address 4 allocated thereto receives a voltage of ( 3/6) V₁. This coincides with the result of M=6, J=4 obtained from the voltage calculation formula.

The voltage generating unit 60 having the configuration of FIG. 7 includes the plural resistor ladder circuits according to the physical arrangement of the ports, thus enabling avoidance of extended layout of wires while using the same voltage calculation formula as in the case of FIG. 5.

### 5. Flowchart

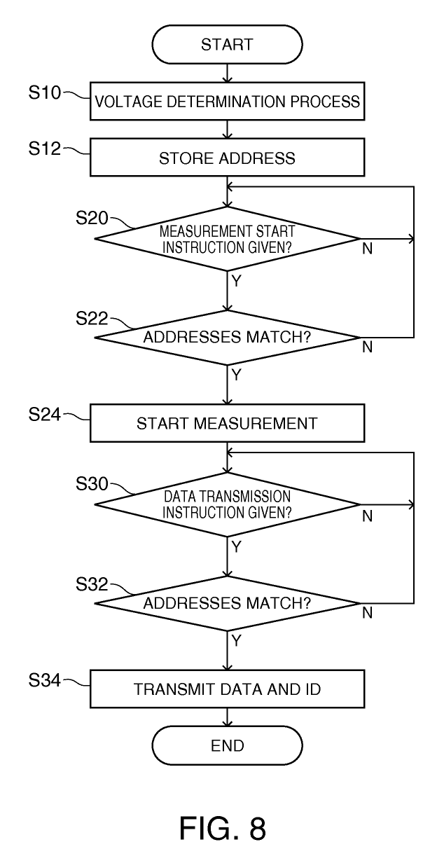

FIG. 8 is a flowchart showing control of the sensor module in the sensor system of this embodiment. Specifically, this is the control carried out by the CPU 40 of FIG. 2, for example, according to a program stored in the storage unit 41.

When the sensor module is connected to a port, the sensor module receives a voltage corresponding to the address of the port and carries out the voltage determination process (S10). The voltage determination process is a process to determine the address of the connected port based on the received voltage.

The sensor module stores the address in the storage unit 41 (S12). After that, the sensor module waits for an instruction to start measurement from the control unit (S20: N). In this embodiment, the measurement is to detect acceleration or angular velocity. When an instruction to start measurement is given (S20: Y), the sensor module determines whether the address of the port designated in the command matches the address of the port to which the sensor module is connected (S22). If these addresses match (S22: Y), the sensor module starts the measurement (S24). If the addresses do not match, the sensor module waits for the next instruction (S22: N).

After the measurement, the sensor module waits for an instruction to transmit data, from the control unit (S30: N). When an instruction to transmit data is given (S30: Y), the sensor module determines whether the address of the port designated in the command matches the address of the port to which the sensor module is connected (S32). If the addresses match (S32: Y), the sensor module transmits the measured data and the sensor module's own unique ID (S34). If the addresses do not match, the sensor module waits for the next instruction (S32: N).

Before the voltage determination process (S10), the sensor module may receive the reference voltage V₁ and the number of ports M through a broadcast from the control unit, that is, without designating a specific port address.

Also, before the instruction to start measurement (S20), an instruction to transmit the ID only may be given by the control unit. In this case, the sensor module transmits the sensor module's own unique ID if the addresses match. At this time, the control unit can check the connection state between the port and the sensor module.

As described above, according to this embodiment, a sensor system in which wire-connected sensor modules can be identified individually without fixing the connecting positions of the sensor modules can be provided.

### 6. Others

The invention includes substantially the same configurations as the configuration described in the embodiment (for example, a configuration with the same function, method and result, or a configuration with the same purpose and effect). Also, the invention includes configurations in which non-essential parts of the configuration described in the embodiment are replaced. Moreover, the invention includes configurations that achieve the same advantages and effects as the configuration described in the embodiment, or configurations that can achieve the same purpose. Furthermore, the invention includes configurations in which the related-art technique is added to the configuration described in the embodiment.

The entire disclosure of Japanese Patent Application No. 2012-087126, filed Apr. 6, 2012 is expressly incorporated by reference herein.

What is claimed is:

1. A sensor system comprising:
plural sensor modules, having a unique identification data;
a connecting unit which has plural ports, having a unique address allocated thereto, and which connects the sensor modules to each of the ports;
a voltage generating unit which generates a different voltage for each of the addresses and supplies the voltage to each of the plural sensor modules; and
a control unit which communicates with the sensor modules via the connecting unit;
wherein the sensor module
determines the address of the port based on the voltage from the voltage generating unit, and transmits a physical quantity that is detected and the unique identification data to the control unit.

2. The sensor system according to claim 1, wherein
the control unit
includes a reference voltage generating unit which supplies a reference voltage to the voltage generating unit, and
the voltage generating unit
performs resistive division of the reference voltage and thus generates different voltages from each other corresponding to the address.

3. The sensor system according to claim 2, wherein
the voltage generating unit
includes plural resistor ladder circuits in which resistance elements are connected in series, and
a resistance value of the resistor elements is decided in such a way that all the voltages obtained by resistive division of the reference voltage differ from each other.

4. The sensor system according to claim 1, wherein
the sensor module,
before detecting the physical quantity,
receives information of the reference voltage and the number of the ports from the control unit via the connecting unit.

5. The sensor system according to claim 1, wherein
the sensor module
includes at least one of an acceleration sensor and an angular velocity sensor.

6. A sensor module identification method comprising:
causing a sensor module connected to a port and having a unique identification data, to determine an address of the port; and
causing the sensor module to transmit a physical quantity that is detected and the unique identification data to a control unit.
